(19) United States
(12) Patent Application Publication
(10) Pub. No.: US 2025/0103454 A1
(43) Pub. Date: Mar. 27, 2025

(54) APPARATUSES, METHODS, AND COMPUTER PROGRAM PRODUCTS FOR INITIATING PERFORMANCE OF ONE OR MORE OBJECT RELATED ACTIONS

(71) Applicant: Honeywell International Inc., Charlotte, NC (US)

(72) Inventors: Ankit Singh, Apex, NC (US); Daniel Burns, Allentown, NJ (US); Stephen McCarthy, Manchester (GB); Amy Spizzirri, Dallas, TX (US)

(21) Appl. No.: 18/891,142

(22) Filed: Sep. 20, 2024

Related U.S. Application Data
(60) Provisional application No. 63/584,648, filed on Sep. 22, 2023.

(51) Int. Cl. G06F 11/30; G06F 11/32; G06F 11/34

(52) U.S. Cl. CPC G06F 11/3055; G06F 11/327; G06F 11/3409

(57) ABSTRACT

Systems, apparatuses, methods, and computer program products are provided herein. For example, the method includes identifying production data representative of an object process and an object. In some embodiments, the object process comprises a plurality of subsidiary object processes. In some embodiments, the method includes generating an object process state representation template using the production data. In some embodiments, the method includes, from at least one of the plurality of processing systems, operational data. In some embodiments, the method includes the operational data to determine an object process state. In some embodiments, processing the operational data comprises applying the operational data to an object process state model. In some embodiments, the method includes generating an object process state representation in response to determining the object process state. In some embodiments, the method includes initiating performance of one or more object related actions based on the object process state representation.

### CROSS REFERENCE TO RELATED APPLICATIONS

This application claims the benefit of U.S. Provisional Application No. 63/584,648 filed Sep. 22, 2023, and entitled “APPARATUSES, METHODS, AND COMPUTER PROGRAM PRODUCTS FOR DETERMINING OBJECT PROCESS STATE,” which is hereby incorporated by reference in its entirety.

### TECHNOLOGICAL FIELD

Embodiments of the present disclosure generally relate to systems apparatuses, methods, and computer program products for initiating performance of one or more object related actions.

### BACKGROUND

Applicant has discovered problems with current implementations of performing object processes. Through applied effort, ingenuity, and innovation, Applicant has solved many of these identified problems by developing embodied in the present disclosure, which are described in detail below.

### BRIEF SUMMARY

Various embodiments described herein relate to systems, apparatuses, methods, and computer program products for initiating performance of one or more object related actions.

In accordance with one aspect of the disclosure, a method is provided. In some embodiments, the method includes identifying production data representative of an object process and an object. In some embodiments, the object process comprises a plurality of subsidiary object processes. In some embodiments, the method includes generating an object process state representation template using the production data. In some embodiments, generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes. In some embodiments, the method includes receiving, from at least one of the plurality of processing systems, operational data. In some embodiments, the method includes processing the operational data to determine an object process state. In some embodiments, processing the operational data comprises applying the operational data to an object process state model. In some embodiments, the method includes generating an object process state representation in response to determining the object process state. In some embodiments, the method includes initiating performance of one or more object related actions based on the object process state representation.

In some embodiments, initiating performance of the one or more object related actions based on the object process state representation comprises generating an object process state representation interface component.

In some embodiments, the object process state representation interface component comprises one or more interface elements.

In some embodiments, initiating performance of the one or more object related actions based on the object process state representation comprises causing the object process state representation interface component to be rendered to an object process interface.

In some embodiments, the one or more interface elements comprises one or more subsidiary object process interface elements.

In some embodiments, the one or more subsidiary object process interface elements are organized on the object process state representation interface component based on the object process state.

In some embodiments, initiating performance of the one or more object related actions based on the object process state representation comprises causing the first processing system of the plurality of processing systems to stop performing the first subsidiary object process.

In some embodiments, initiating performance of the one or more object related actions based on the object process state representation comprises causing the first processing system of the plurality of processing systems to adjust the first subsidiary object process.

In some embodiments, initiating performance of the one or more object related actions based on the object process state representation comprises transmitting an object process state alert to a client device.

In some embodiments, the method includes initiating performance of one or more preliminary object related actions based on the object process state representation template.

In some embodiments, initiating performance of the one or more preliminary object related actions based on the object process state representation template comprises generating an object process state representation template interface component.

In some embodiments, the object process state representation template interface component comprises one or more interface elements.

In some embodiments, initiating performance of the one or more preliminary object related actions based on the object process state representation template comprises causing the object process state representation template interface component to be rendered to an object process interface.

In some embodiments, initiating performance of the one or more preliminary object related actions based on the object process state representation template comprises causing the first processing system of the plurality of processing systems to perform the first subsidiary object process.

In some embodiments, the object process state indicates that the object process is associated with an anomaly.

In some embodiments, the object process state indicates that the object process is at an increased risk of suffering an anomaly.

In accordance with another aspect of the disclosure, an apparatus is provided. In some embodiments, the apparatus comprises memory and one or more processors communicatively coupled to the memory. In some embodiments, the one or more processors are configured to identify production data representative of an object process and an object. In some embodiments, the object process comprises a plurality of subsidiary object processes. In some embodiments, the one or more processors are configured to generate an object process state representation template using the production data. In some embodiments, generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes. In some embodiments, the one or more processors are configured to receive, from at least one of the plurality of processing systems, operational data. In some embodiments, the one or more processors are configured to process the operational data to determine an object process state. In some embodiments, process the operational data comprises applying the operational data to an object process state model. In some embodiments, the one or more processors are configured to generate an object process state representation in response to determining the object process state. In some embodiments, the one or more processors are configured to initiate performance of one or more object related actions based on the object process state representation.

In some embodiments, to initiate performance of the one or more object related actions based on the object process state representation comprises the one or more processors being further configured to generate an object process state representation interface component.

In some embodiments, the object process state representation interface component comprises one or more interface elements.

In some embodiments, to initiate performance of the one or more object related actions based on the object process state representation comprises the one or more processors being further configured to cause the object process state representation interface component to be rendered to an object process interface.

In some embodiments, the one or more interface elements comprises one or more subsidiary object process interface elements.

In some embodiments, the one or more subsidiary object process interface elements are organized on the object process state representation interface component based on the object process state.

In some embodiments, to initiate performance of the one or more object related actions based on the object process state representation comprises the one or more processors being further configured to cause the first processing system of the plurality of processing systems to stop performing the first subsidiary object process.

In some embodiments, to initiate performance of the one or more object related actions based on the object process state representation comprises the one or more processors being further configured to cause the first processing system of the plurality of processing systems to adjust the first subsidiary object process.

In some embodiments, the one or more processors are further configured to initiate performance of one or more preliminary object related actions based on the object process state representation template.

In accordance with another aspect of the disclosure, a computer program product is provided. In some embodiments, the computer program product includes at least one non-transitory computer-readable storage medium having computer program code stored thereon. In some embodiments, the computer program code, in execution with at least one processor, configures the computer program product for identifying production data representative of an object process and an object. In some embodiments, the object process comprises a plurality of subsidiary object processes. In some embodiments, the computer program code, in execution with at least one processor, configures the computer program product for generating an object process state representation template using the production data. In some embodiments, generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes. In some embodiments, the computer program code, in execution with at least one processor, configures the computer program product for receiving, from at least one of the plurality of processing systems, operational data. In some embodiments, the computer program code, in execution with at least one processor, configures the computer program product for processing the operational data to determine an object process state. In some embodiments, processing the operational data comprises applying the operational data to an object process state model. In some embodiments, the computer program code, in execution with at least one processor, configures the computer program product for generating an object process state representation in response to determining the object process state. In some embodiments, the computer program code, in execution with at least one processor, configures the computer program product for initiating performance of one or more object related actions based on the object process state representation.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 illustrates a block diagram of a first example apparatus that may be specially configured in accordance with an example embodiment of the present disclosure;

FIG. 3 illustrates a block diagram of a second example apparatus that may be specially configured in accordance with an example embodiment of the present disclosure;

FIG. 4 illustrates an interface in accordance with an example embodiment of the present disclosure;

FIG. 5 illustrates an interface in accordance with an example embodiment of the present disclosure;

FIG. 6 illustrates a flowchart of an example method in accordance with an example embodiment of the present disclosure;

FIG. 7 illustrates a flowchart of an example method in accordance with an example embodiment of the present disclosure; and

FIG. 8 illustrates a flowchart of an example method in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Example embodiments disclosed herein address technical problems associated with performing object processes. As would be understood by one skilled in the field to which this disclosure pertains, there are numerous example scenarios in which it may be desirable to perform object processes.

In many applications, systems, apparatuses, methods, and computer program products for performing object processes are desirable. For example, it may be desirable to perform object processes to create and/or generate one or more objects. In some implementations, it may be desirable to perform an object process using a variety of dispersed and specifically configured processing systems to perform particular portions of an object process. In some implementations, it may be desirable to perform an object processing using a variety of dispersed and specifically configured processing systems to perform particular portions of an object process in parallel. In this way, performance of object process can be performed efficiently with a high degree of accuracy.

Example solutions for performing object processes include using a computing device to implement and manage the object processes. However, such example solutions are resource intensive, suffer from high latency, and reactive. For example, such example solutions are resource intensive because such example solutions are unable to automatically associate and/or link portions of an object process to one of a plurality of processing systems specifically configured to perform a particular portion of an object process. As a result, such example solutions consume excessive resources, such as processing power and memory, by not being able to perform portions of object processes on processing systems that are optimized for performing particular portions of an object process. As another example, such example solutions suffer from high latency because such example solutions are unable to implement portions of object processes on different processing systems in parallel. As a result, such example solutions must implement portions of object processes sequentially on a single processing system, which increases latency. As another example, such example solutions are reactive because such example solutions are unable to proactively initiate performance of one or more object related actions based on a determined object processes state. As a result, such example solutions are unable to proactively predict potential anomalies in performance of an object process. Accordingly, there is a need for systems, apparatuses, methods, and computer program products for performing object processes in a resource efficient, low latency, and proactive manner.

Thus, to address these and/or other issues related to such example solutions, example systems, apparatuses, methods, and computer program products for performing object processes are disclosed herein. For example, an embodiment, in this disclosure, described in greater detail below, includes a method that includes identifying production data representative of an object process and an object. In some embodiments, the object process comprises a plurality of subsidiary object processes. In some embodiments, the method includes generating an object process state representation template using the production data. In some embodiments, generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes. In some embodiments, the method includes, from at least one of the plurality of processing systems, operational data. In some embodiments, the method includes the operational data to determine an object process state. In some embodiments, processing the operational data comprises applying the operational data to an object process state model. In some embodiments, the method includes generating an object process state representation in response to determining the object process state. In some embodiments, the method includes initiating performance of one or more object related actions based on the object process state representation. Accordingly, the systems, apparatuses, methods, and computer program products disclosed herein enable performing object processes in a resource efficient, low latency, and proactive manner.

### Definitions

In one or more embodiments, the term “computing device” refers to any computer, processor, circuitry, and/or other executor of computer instructions that is embodied in hardware, software, firmware, and/or any combination thereof. Non-limiting examples of a computing device include a computer, a processor, an application-specific integrated circuit, a field-programmable gate array, a personal computer, a smart phone, a laptop, a fixed terminal, a server, a networking device, and a virtual machine.

In one or more embodiments, the term “user computing device” refers to a computing device associated with a person, company, or other organizational structure that controls one or more systems. In some embodiments, a user computing device is associated with particular administrative credentials that define access to operation via a particular system.

In one or more embodiments, the term “executable code” refers to a portion of computer program code stored in one or a plurality of locations that is executed and/or executable via one or more computing devices embodied in hardware, software, firmware, and/or any combination thereof. Executable code defines at least one particular operation to be executed by one or more computing devices. In some embodiments, a memory, storage, and/or other computing device includes and/or otherwise is structured to define any amount of executable code (e.g., a portion of executable code associated with a first operation and a portion of executable code associated with a second operation). Alternatively, or additionally, in some embodiments, executable code is embodied by separate computing devices (e.g., a first datastore embodying first portion of executable code and a second datastore embodying a second portion executable code).

In one or more embodiments, the term “datastore,” “database,” and “data lake” refer to any type of non-transitory computer-readable storage medium. Non-limiting examples of a datastore, database, and/or data lake include hardware, software, firmware, and/or a combination thereof capable of storing, recording, updating, retrieving and/or deleting computer-readable data and information. In various embodiments, a datastore, database, and/or data lake in some embodiments is a cloud-based storage system accessible via a communications network by one or more components of the various embodiments of the present disclosure.

In one or more embodiments, the term “data value” refers to electronically managed data representing a particular value for a particular data attribute, operational parameter, sensor device, and/or the like.

The phrases “in an embodiment,” “in one embodiment,” “according to one embodiment,” and the like generally mean that the particular feature, structure, or characteristic following the phrase in some embodiments is included in at least one embodiment of the present disclosure, and in some embodiments is included in more than one embodiment of the present disclosure (importantly, such phrases do not necessarily refer to the same embodiment). The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature in some embodiments is optionally included in some embodiments, or it in some embodiments is excluded.

As used herein, the terms “data,” “content,” “digital content,” “data object,” “information,” and similar terms may be used interchangeably to refer to data capable of being transmitted, received, and/or stored in accordance with embodiments of the present invention. Thus, use of any such terms should not be taken to limit the spirit and scope of embodiments of the present invention. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

### Example Embodiment Implementations and Processes of the Disclosure

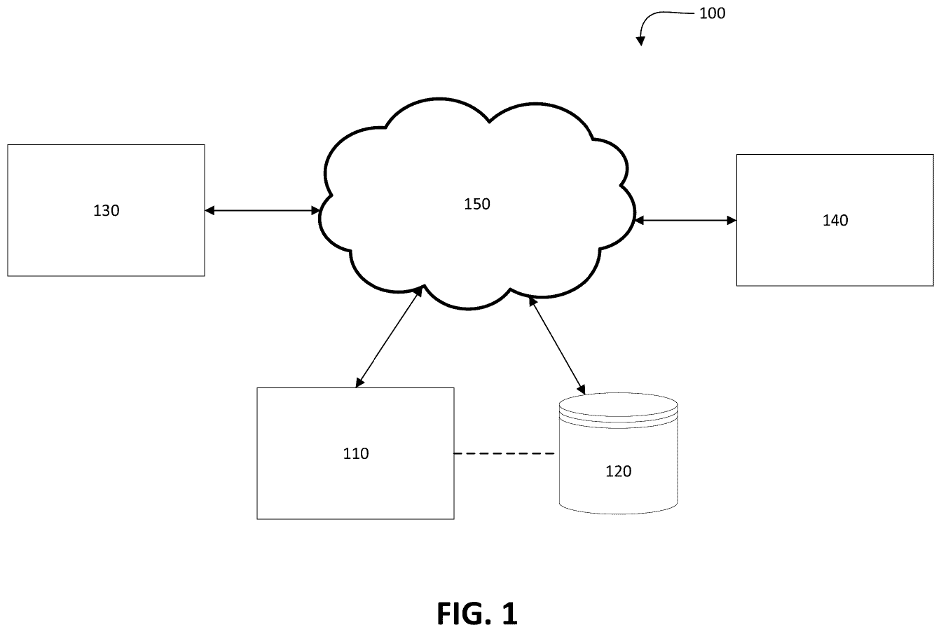

FIG. 1 illustrates a block diagram of a system that may be specially configured within which embodiments of the present disclosure may operate. Specifically, FIG. 1 depicts an example system 100. As illustrated, the system 100 includes an object process optimization system 110, a database 120, one or more client systems, for example client device 140, a plurality of processing systems 130. In some embodiments, the plurality of processing systems 130 includes a quality control laboratory type processing system (e.g., a laboratory information management system (LIMS)). In some embodiments, the plurality of processing systems 130 includes a manufacturing process type processing system. In some embodiments, the plurality of processing systems 130 includes a resource planning type processing system (e.g., an enterprise resource planning (ERP)).

In some embodiments, the object process optimization system 110, client device 140, database 120, and/or plurality of processing systems 130 communicate over one or more communication network(s), for example a communications network 150. It should be appreciated that the communications network 150 in some embodiments is embodied in any of a myriad of network configurations. In some embodiments, the communications network 150 embodies a public network (e.g., the Internet). In some embodiments, the communications network 150 embodies a private network (e.g., an internal localized, or closed-off network between particular devices). In some other embodiments, the communications network 150 embodies a hybrid network (e.g., a network enabling internal communications between particular connected devices and external communications with other devices). The communications network 150 in some embodiments includes one or more base station(s), relay(s), router(s), switch(es), cell tower(s), communications cable(s) and/or associated routing station(s), and/or the like. In some embodiments, the communications network 150 includes one or more user-controlled computing device(s) (e.g., a user owned router and/or modem) and/or one or more external utility devices (e.g., Internet service provider communication tower(s) and/or other device(s)).

Each of the components of the system 100 communicatively coupled to transmit data to and/or receive data from one another over the same or different wireless and/or wired networks embodying the communications network 150. Such configuration(s) include, without limitation, a wired or wireless Personal Area Network (PAN), Local Area Network (LAN), Metropolitan Area Network (MAN), Wide Area Network (WAN), and/or the like. Additionally, while FIG. 1 illustrate certain system entities as separate, standalone entities communicating over the communications network 150, the various embodiments are not limited to this architecture. In other embodiments, one or more computing entities share one or more components, hardware, and/or the like, or otherwise are embodied by a single computing device such that connection(s) between the computing entities are over the communications network 150 are altered and/or rendered unnecessary. For example, in some embodiments, the object process optimization system 110 includes some or all of a client system (e.g., the client device 140) and/or the plurality of processing systems 130, such that an external communications network 150 is not required.

A client device 140 in some embodiments includes any number of computing device(s), system(s), physical component(s), and/or the like, that facilitates access to functionality performed by the object process optimization system 110 and/or associated with computing task(s) associated with the object process optimization system 110. In some embodiments, a client device 140 includes or otherwise is communicable with the object process optimization system 110 to access and/or output results of remote functionality, and/or provide local functionality associated with a computing task processed by the object process optimization system 110. In some embodiments, the client device 140 includes a display that renders data to a user of the client device 140, and/or receives user input for processing. Additionally, or alternatively, in some embodiments, the client device 140 includes one mor more peripherals and/or other associated devices that enable interaction with functionality provided by the client device 140, either directly or through communication with the object process optimization system 110. In some embodiments, a client device 140 includes one or more end user terminal(s), smartphone, tablet, personal computer, smart device, laptop, server(s), and/or the like that are configured to perform such functions. Additionally, or alternatively, in some embodiments, the client device 140 includes one or more user device(s) that enables access to functionality provided by the object process optimization system 110, for example via a web application, native application, and/or the like. Alternatively, or additionally still, in some embodiments, the client device 140 is specially configured to provide access to the functionality of the object process optimization system 110 utilizing at least one client-server based messaging protocol.

The object process optimization system 110 includes one or more computing device(s), system(s), and/or the like embodied in hardware, software, firmware, and/or a combination thereof, that provides particular application functionality. The application functionality may be accessed locally (e.g., via peripherals attached to or otherwise communicable with the object process optimization system 110 itself), and/or remotely (e.g., via interaction with the client device 140). In some embodiments, the object process optimization system 110 includes one or more specially configured application server(s), database server(s), enterprise terminal(s), backend server(s), cloud computing system(s), and/or the like.

The database 120 includes hardware, software, firmware, and/or any combination thereof, configured to store data utilized by and/or produced by functionality of the object process optimization system 110. In some embodiments, the database 120 embodies a sub-system of the object process optimization system 110. Additionally, or alternatively, in some embodiments, the database 120 embodies a remotely located data repository communicable with the object process optimization system 110. The object process optimization system 110 may communicate with the database 120 directly in some embodiments, and/or in some embodiments communicates via one or more communications networks, for example the communications network 150. In some embodiments, the database 120 includes one or more specially configured database server(s), enterprise terminal(s), backend server(s), cloud computing system(s), non-transitory memory device(s), and/or the like.

In some embodiments, the object process optimization system 110, the database 120, the one or more client systems, for example client device 140, and/or the plurality of processing systems 130 communicate with one another to perform the various actions described herein. For example, in some embodiments, object process optimization system 110 communicates with the client device 140 to provide an end user access to functionality to an end user. The functionality may be performed by the object process optimization system 110 alone, the object process optimization system 110 in conjunction with the database 120, the object process optimization system 110 in conjunction with any of the plurality of processing systems 130, and/or any combination thereof.

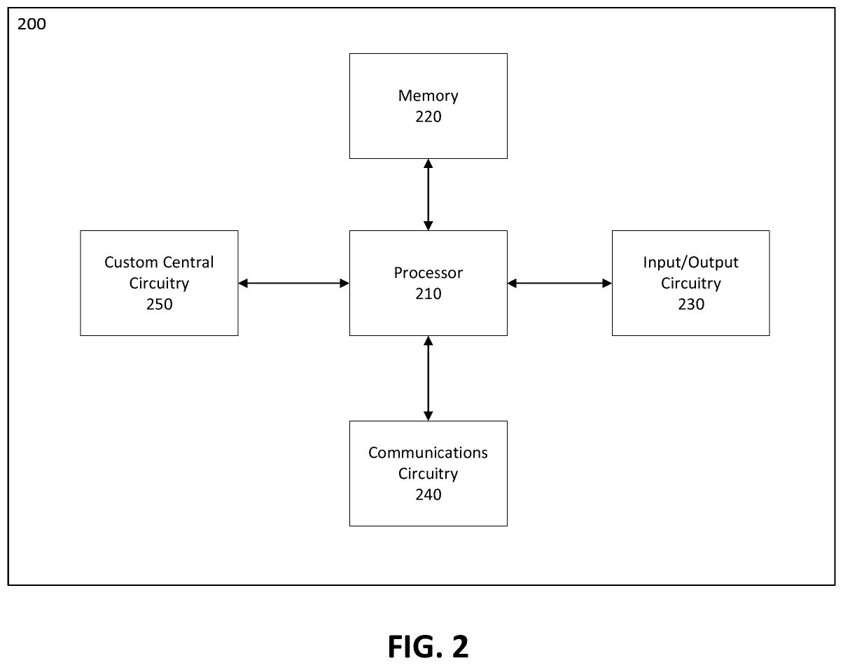

FIG. 2 illustrates a block diagram of an example apparatus that may be specially configured in accordance with at least one example embodiment of the present disclosure. Specifically, FIG. 2 depicts an example object process optimization apparatus (“apparatus 200”) specially configured in accordance with at least some example embodiments of the present disclosure. In some embodiments, the object process optimization system 110 and/or a portion thereof is embodied by one or more system(s), such as the apparatus 200 as depicted and described in FIG. 2. The apparatus 200 includes processor 210, memory 220, input/output circuitry 230, communications circuitry 240, and/or custom central circuitry 250. In some embodiments, the apparatus 200 is configured, using one or more of the sets of circuitry embodied by processor 210, memory 220, input/output circuitry 230, communications circuitry 240, and/or custom central circuitry 250, to execute and perform the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the apparatus 200 embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the apparatus 200 provide or supplement the functionality of another particular set of circuitry. For example, the processor 210 in some embodiments provides processing functionality to any of the sets of circuitry, the memory 220 provides storage functionality to any of the sets of circuitry, the communications circuitry 240 provides network interface functionality to any of the sets of circuitry, and/or the like.

In some embodiments, the processor 210 (and/or co-processor or any other processing circuitry assisting or otherwise associated with the processor) is/are in communication with the memory 220 via a bus for passing information among components of the apparatus 200. In some embodiments, for example, the memory 220 is non-transitory and may include, for example, one or more volatile and/or non-volatile memories. In other words, for example, the memory 220 in some embodiments includes or embodies an electronic storage device (e.g., a computer readable storage medium). In some embodiments, the memory 220 is configured to store information, data, content, applications, instructions, or the like, for enabling the apparatus 200 to carry out various functions in accordance with example embodiments of the present disclosure.

The processor 210 may be embodied in a number of different ways. For example, in some example embodiments, the processor 210 includes one or more processing devices configured to perform independently. Additionally, or alternatively, in some embodiments, the processor 210 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the apparatus 200, and/or one or more remote or “cloud” processor(s) external to the apparatus 200.

In an example embodiment, the processor 210 is configured to execute instructions stored in the memory 220 or otherwise accessible to the processor. Alternatively, or additionally, the processor 210 in some embodiments is configured to execute hard-coded functionality. As such, whether configured by hardware or software methods, or by a combination thereof, the processor 210 represents an entity (e.g., physically embodied in circuitry) capable of performing operations according to an embodiment of the present disclosure while configured accordingly. Alternatively, or additionally, as another example in some example embodiments, when the processor 210 is embodied as an executor of software instructions, the instructions specifically configure the processor 210 to perform the algorithms embodied in the specific operations described herein when such instructions are executed.

As one particular example embodiment, the processor 210 is configured to perform various operations associated with providing functionality of the object process optimization system 110, either alone or in conjunction with one or more external systems (e.g., any one or more of the plurality of processing systems 130 and/or client device 140). For example, in some embodiments, the processor 210 includes hardware, software, firmware, and/or any combination thereof, that is configured to provide functionality supported by one or more applications executed based on instructions stored by and/or otherwise accessible to the processor 210.

In some embodiments, the apparatus 200 includes communications circuitry 240. The communications circuitry 240 includes any means such as a device or circuitry embodied in either hardware or a combination of hardware and software that is configured to receive and/or transmit data from/to a network and/or any other device, circuitry, or module in communication with the apparatus 200. In this regard, in some embodiments the communications circuitry 240 includes, for example, a network interface for enabling communications with a wired or wireless communications network. Additionally, or alternatively in some embodiments, the communications circuitry 240 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 240 includes circuitry for interacting with the antenna(s) and/or other hardware or software to cause transmission of signals via the antenna(s) or to handle receipt of signals received via the antenna(s). In some embodiments, the communications circuitry 240 enables transmission to and/or receipt of data from client device, and/or other external computing system in communication with the apparatus 200.

In some embodiments, the apparatus 200 includes custom central circuitry 250. The custom central circuitry 250 includes hardware, software, firmware, and/or a combination thereof, that supports custom functionality of the object process optimization system 110. For example, in some embodiments, the custom central circuitry 250 includes hardware, software, firmware, and/or a combination thereof, that identifies production data representative of an object process and/or an object. Additionally, or alternatively, in some embodiments, the custom central circuitry 250 includes hardware, software, firmware, and/or a combination thereof, that generates an object process state representation template based on the production data. Additionally, or alternatively, in some embodiments, the custom central circuitry 250 includes hardware, software, firmware, and/or a combination thereof, that receives, from the plurality of processing systems 130, operational data. Additionally, or alternatively, in some embodiments, the custom central circuitry 250 includes hardware, software, firmware, and/or a combination thereof, that processes the operational data to determine an object process state. Additionally, or alternatively, in some embodiments, the custom central circuitry 250 includes hardware, software, firmware, and/or a combination thereof, that generates an object process state representation in response to determining the object process state. Additionally, or alternatively, in some embodiments, the custom central circuitry 250 includes hardware, software, firmware, and/or a combination thereof, that initiates performance of one or more object related actions. In some embodiments, custom central circuitry 250 includes a separate processor, specially configured field programmable gate array (FPGA), or a specially programmed application specific integrated circuit (ASIC).

Additionally, or alternatively, in some embodiments, two or more of the sets of circuitries embodying processor 210, memory 220, input/output circuitry 230, communications circuitry 240, and/or custom central circuitry 250. Alternatively, or additionally, in some embodiments, one or more of the sets of circuitry perform some or all of the functionality described associated with another component. For example, in some embodiments, two or more of the sets of circuitry embodied by processor 210, memory 220, input/output circuitry 230, communications circuitry 240, and/or custom central circuitry 250, are combined into a single module embodied in hardware, software, firmware, and/or a combination thereof. Similarly, in some embodiments, one or more of the sets of circuitry, for example custom central circuitry 250, is combined with the processor 210, such that the processor 210 performs one or more of the operations described above with respect to each of these sets of circuitry embodied by the custom central circuitry 250.

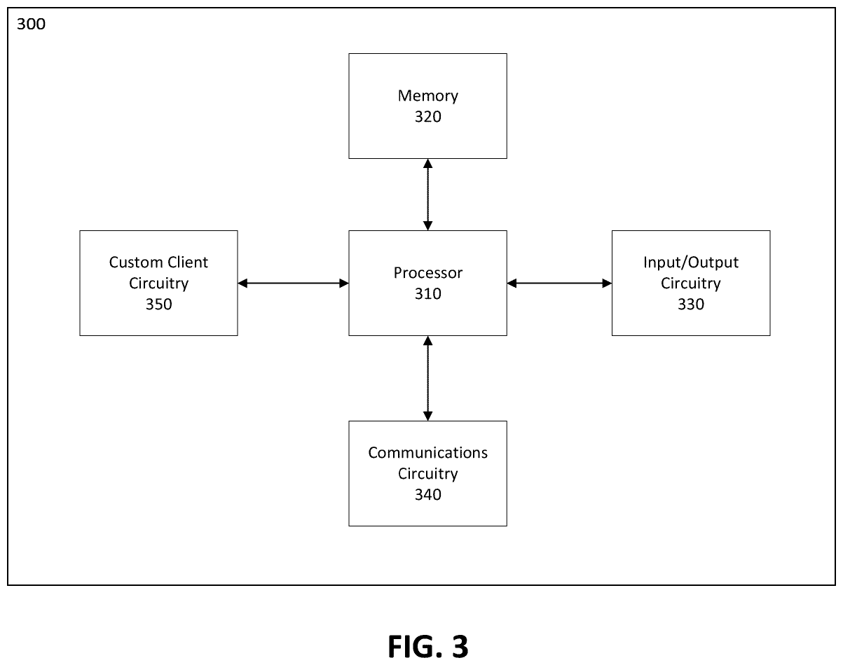

FIG. 3 illustrates a block diagram of an example apparatus embodying a client system and/or a processing system in accordance with at least one embodiment of the present disclosure. Specifically, FIG. 3 illustrates an example client apparatus 300 (“apparatus 300”) specifically configured in accordance with at least one example embodiment of the present disclosure. In some embodiments one or more client systems, for example client device 140, is/are embodied by one or more system(s), device(s), and/or the like, such as the apparatus 300 as depicted and described in FIG. 3. Additionally, or alternatively, one or more processing systems, for example one or more of the plurality of processing systems 130, is/are embodied by one or more system(s), device(s), and/or the like, such as the apparatus 300 as depicted and described in FIG. 3. The apparatus 300 includes processor 310, memory 320, input/output circuitry 330, communications circuitry 340, and custom client circuitry 350. In some embodiments, the apparatus 300 is configured, using one or more of the processor 310, memory 320, input/output circuitry 330, communications circuitry 340, and custom client circuitry 350, to execute and perform one or more of the operations described herein.

In some embodiments, the processor 310, memory 320, input/output circuitry 330, and communications circuitry 340, function similarly or identically to the similarly named sets of circuitry embodying processor 210, memory 220, input/output circuitry 230, and communications circuitry 240 as depicted and described with respect to the apparatus 200 in FIG. 2. Additionally, or alternatively, in some embodiments, the processor 310 includes hardware, software, firmware, and/or a combination thereof, that supports functionality performed by the client device 140 and/or the plurality of processing systems 130, as depicted and described with respect to FIG. 1. For example, in some embodiments, the processor 310 includes hardware, software, firmware, and/or a combination thereof, that supports connection with, access to, and/or other communication with the object process optimization system 110, and/or transmission of data to the object process optimization system 110, receiving of data from the object process optimization system 110, outputting of data from the object process optimization system 110, performing object processes, and/or provision of user input associated with functionality of or associated with the object process optimization system 110. For purposes of brevity, repeated disclosure with respect to the functionality of such similarly-named sets of circuitry is omitted herein.

In some embodiments, the apparatus 300 includes custom client circuitry 350. The custom client circuitry 350 includes hardware, software, firmware, and/or a combination thereof, that supports generation and/or outputting of an application (e.g., a native application and/or a browser application that provides access to one or more web application) associated with functionality of the object process optimization system 110, for example embodied by the apparatus 200. In some such embodiments, the application supported by the custom client circuitry 350 is configured to output one or more user interface(s) that provides data generated by and/or otherwise associated with the functionality of and/or otherwise associated with the object process optimization system 110, and/or receives input for accessing functionality of or otherwise associated with the object process optimization system 110. In some such embodiments, the custom client circuitry 350 includes hardware, software, firmware, and/or any combination thereof, that generates and transmits one or more messages and/or requests to the object process optimization system 110 associated with accessing particular functionality of the object process optimization system 110. Additionally, or alternatively, in some embodiments the custom client circuitry 350 includes hardware, software, firmware, and/or any combination thereof, that receives and processes one or more messages and/or responses from the object process optimization system 110 embodying or otherwise associated with the results of particular functionality of the object process optimization system 110. Additionally, or alternatively, in some embodiments the custom client circuitry 350 includes hardware, software, firmware, and/or any combination thereof, that performs one or more object processes. Additionally, or alternatively, in some embodiments the application configured by the custom client circuitry 350 provides local functionality associated with the object process optimization system 110, functionality thereof, and/or a related computing task.

Additionally, or alternatively, in some embodiments, two or more of the sets of circuitries embodying processor 310, memory 320, input/output circuitry 330, communications circuitry 340, and/or custom client circuitry 350. Alternatively, or additionally, in some embodiments, one or more of the sets of circuitry perform some or all of the functionality described associated with another component. For example, in some embodiments, two or more of the sets of circuitry embodied by processor 310, memory 320, input/output circuitry 330, communications circuitry 340, and/or custom client circuitry 350, are combined into a single module embodied in hardware, software, firmware, and/or a combination thereof. Similarly, in some embodiments, one or more of the sets of circuitry, for example custom client circuitry 350, is combined with the processor 310, such that the processor 310 performs one or more of the operations described above with respect to each of these sets of circuitry embodied by the custom client circuitry 350.

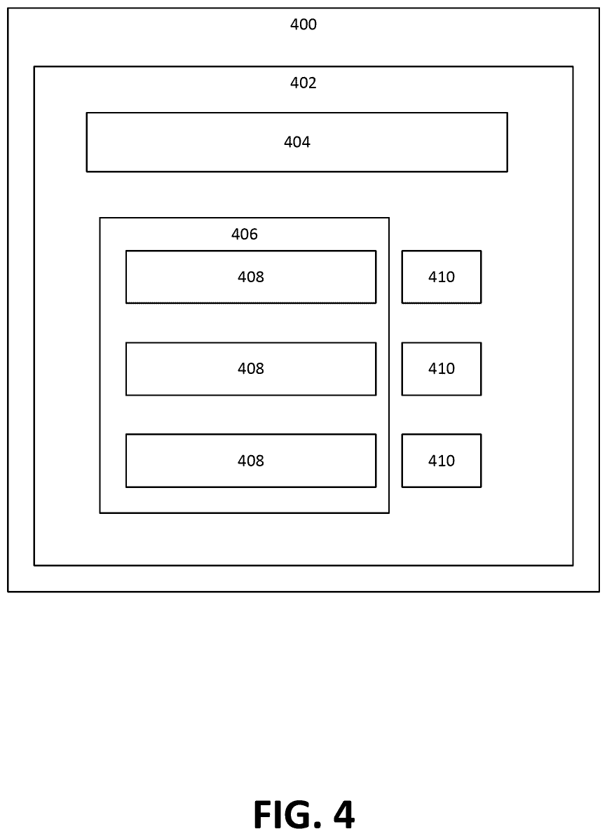

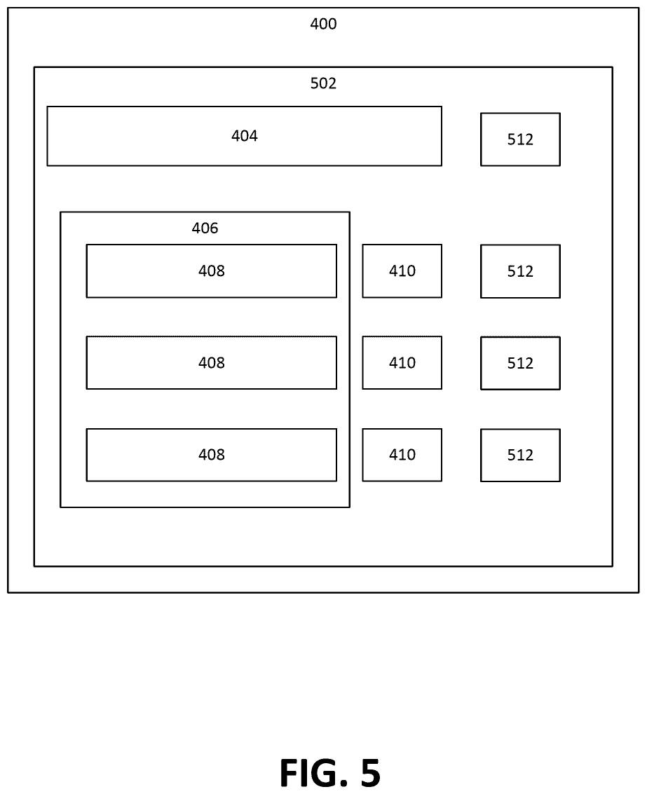

With reference to FIGS. 1-5, in some embodiments, the object process optimization system 110 is configured to identify production data. In some embodiments, production data includes one or more items of data representative and/or indicative of a plurality of object processes. In some embodiments, an object process is a process, routine, task, and/or the like for generating and/or creating an object that is performed by one or more of the plurality of processing systems 130 and/or an operator associated with one or more of the plurality of processing systems 130. In some embodiments, an object process includes one or more subsidiary object processes. In some embodiments, a subsidiary object process is a process, routine, task, and/or the like for at least partially generating and/or creating an object that is performed by a processing system of the plurality of processing systems 130 and/or an operator associated with a processing system of the plurality of processing systems 130. Said differently, for example, a subsidiary object process is associated with a portion and/or a part of an object process.

In some embodiments, production data includes one or more items of data representative and/or indicative of a plurality of objects. In some embodiments, an object is a product, item, and/or the like that is created and/or generated by an object process. For example, an object may include one or more pharmaceuticals, medical devices, biologics, manufactured devices, and/or the like. In some embodiments, production data includes one or more items of data representative and/or indicative of a plurality of resources used to generate and/or create an object and/or to perform an object process. For example, the plurality of resources may include resources used by the plurality of processing systems 130 to generate and/or create an object and/or to perform an object process. In some embodiments, production data includes one or more items of data representative and/or indicative of equipment used to generate and/or create an object and/or to perform an object process. For example, the equipment may include equipment used by the plurality of processing systems 130 to generate and/or create an object and/or to perform an object process (e.g., manufacturing equipment). In some embodiments, production data includes one or more items of data representative and/or indicative of material and/or input ingredients used to generate and/or create an object and/or to perform an object process. For example, the material and/or input ingredients may include material and/or input ingredients used by the plurality of processing systems 130 to generate and/or create an object and/or to perform an object process (e.g., raw materials).

In some embodiments, identifying production data includes the object process optimization system 110 being configured to receive production data. For example, production data may be received by the object process optimization system 110 from one or more of the plurality of processing systems 130. As another example, production data may be received by the object process optimization system 110 from one or more external systems and/or databases (e.g., the database 120). In some embodiments, production data may be received in a variety of standardized formats. For example, each of the plurality of processing systems 130 may provide production data in a different format.

In some embodiments, identifying production data includes the object process optimization system 110 being configured to generate production data. For example, production data may be generated using operational data. As another example, production data may be generated using historical production data. In some embodiments, generating production data includes the object process optimization system 110 being configured to convert unstandardized production data received by the object process optimization system 110 into a standard format. In this regard, for example, the object process optimization system 110 may be configured to receive production data from the plurality of processing systems 130 in a variety of unstandardized formats and convert the received production data into a standardized format.

In some embodiments, the object process optimization system 110 is configured to generate an object process state representation template. In some embodiments, an object process state representation template is a data object representative and/or indicative of an object. For example, an object process state representation template may be indicative of a first object of the plurality of objects represented by production data. Additionally, or alternatively, an object process state representation template is a data object representative and/or indicative of an object process. For example, an object process state representation template may be indicative of a first object process associated with the first object (e.g., an object process state representation template is indicative of a particular object and an object process associated with the particular object).

Additionally, or alternatively, an object process state representation template is a data object representative and/or indicative of a plurality of subsidiary object processes. For example, an object process state representation template may be indicative of a first plurality of subsidiary object processes associated with the first object process (e.g., an object process state representation template is indicative of the subsidiary object process in the first object process). Additionally, or alternatively, an object process state representation template is a data object representative and/or indicative of a processing system of the plurality of processing systems 130 associated with each of a plurality of subsidiary object processes. For example, an object process state representation template may be indicative of a first processing system of the plurality of processing systems 130 associated with a first subsidiary object process of the plurality of subsidiary object processes. As another example, an object process state representation template may be indicative of a second processing system of the plurality of processing systems 130 associated with a second subsidiary object process of the plurality of subsidiary object processes. (e.g., an object process state representation template is indicative of which of the plurality of processing systems 130 is configured to perform a particular subsidiary object process).

In some embodiments, the object process optimization system 110 is configured to generate an object process state representation template using production data. In this regard, in some embodiments, generating an object process state representation template may include identifying and/or extracting an object from the plurality of objects represented by production data. In some embodiments, generating an object process state representation template may include identifying and/or extracting an object process associated with the identified object from the plurality of object processes represented by production data. In some embodiments, generating an object processes state representation template may include identifying and/or extracting a plurality of subsidiary object processes associated with the identified object process from the plurality of subsidiary object processes represented by the production data. In some embodiments, generating an object process state representation template may include associating and/or linking each of the plurality of subsidiary object processes with a processing system of the plurality of processing systems 130. For example, generating an object process state representation template may include associating and/or linking a first processing system of the plurality of processing systems 130 with a first subsidiary object of the plurality of subsidiary processes. As another example, generating an object process state representation template may include associating and/or linking a second processing system of the plurality of processing systems 130 with a second subsidiary object process of the plurality of subsidiary object processes. In this regard, for example, the object process optimization system 110 is configured to determine which processing system of the plurality of processing systems 130 should perform each subsidiary object process of the plurality of subsidiary object processes.

In some embodiments, the object process optimization system 110 is configured to receive operational data. In some embodiments, operational data is received by the object process optimization system 110 from one or more of the plurality of processing systems 130. Additionally, or alternatively, operational data is received by the object process optimization system 110 from the database 120. Additionally, or alternatively, operational data is received by the object process optimization system 110 from one or more other systems external to the object process optimization system 110. In some embodiments, operational data is received by the object process optimization system 110 in real-time. In this regard, for example, operational data by the object process optimization system 110 as a processing system is performing a subsidiary object process.

In some embodiments, operational data includes one or more items of data representative and/or indicative of operations of an object process and/or one or more subsidiary object processes. For example, operational data may include bioreactor parameters, temperatures, pressures, pHs, oxygen levels, dissolved oxygen levels, destructive testing parameters, reaction cycle time, and/or the like associated with an object process and/or a subsidiary object process.

In some embodiments, operational data includes testing routine data. In some embodiments, testing routine data includes one or more items of data representative and/or indicative of testing routines that are performed by one or more processing systems of the plurality of processing systems 130 to perform an object process and/or a subsidiary object process. For example, testing routine data may include one or more items of data representative and/or indicative of one or more physical, chemical, and/or microbiological tests that are performed during an object process and/or a subsidiary object process by a processing system. In this regard, for example, testing routine data may indicate whether one or more tests performed during an object process and/or a subsidiary object process are successful or unsuccessful. In some embodiments, operational data includes production data.

In some embodiments, operational data includes genealogy data. In some embodiments, genealogy data includes one or more items of data representative and/or indicative of input ingredient quality for input ingredients that are used by one or more processing systems of the plurality of processing systems 130 to perform an object process and/or a subsidiary object process. For example, genealogy data may include one or more items of data representative and/or indicative of an input ingredient quality index for input ingredients that are used during an object process and/or a subsidiary object process by a processing system. In this regard, for example, genealogy data may indicate whether an input ingredient quality index for input ingredients used during an object process and/or a subsidiary object process meet or do not meet a quality threshold.

In some embodiments, operational data includes labeling data. In some embodiments, labeling data includes one or more items of data representative and/or indicative of labeling associated with an object that is generated and/or created by one or more processing systems of the plurality of processing systems 130 when performing an object process and/or a subsidiary object process. For example, labeling data may include one or more items of data representative and/or indicative of one or more labels that are fixed to an object during an object process and/or a subsidiary object process by a processing system. In this regard, for example, labeling data may indicate whether a label associated with an object meets particular regulation requirements and/or is up to date.

In some embodiments, operational data includes registration data. In some embodiments, registration data includes one or more items of data representative and/or indicative whether an object that is being generated and/or created by an object process and/or subsidiary object process has been or will be registered in one or more geographies. For example, registration data may include one or more items of data representative and/or indicative of one or more geographies in which an object needs to be registered. In some embodiments, operational data includes distribution data. In some embodiments, distribution data includes one or more items of data representative and/or indicative of distribution parameters associated with an object that is being generated and/or created by an object process and/or subsidiary object process performed by one or more processing systems of the plurality of processing systems 130. For example, distribution data may include one or more items of data representative and/or indicative of whether distribution parameters associated with an object indicate that an object is ready to be distributed.

In some embodiments, operational data includes technical data. In some embodiments, technical data includes one or more items of data representative and/or indicative of technical features associated with one or more processing systems of the plurality of processing systems 130. For example, technical data may include one or more items of data representative and/or indicative of whether a particular processing system is configured to perform a particular subsidiary object process.

In some embodiments, the object process optimization system 110 is configured to process operational data to determine an object process state. In some embodiments, an object process state is a data object that indicates a state associated with an object process. For example, an object process state may be a data object that indicates that an object process has not started. As another example, an object process state may be a data object that indicates that an object process is in progress. As another example, an object process state may be a data object that indicates that an object process is partially completed (e.g., a percent completed). As another example, an object process state may be a data object that indicates that an object process is completed. As another example, an object process state may be a data object that indicates that an object process is associated with an anomaly (e.g., due to an anomaly associated with the object process, the plurality of processing systems 130 will fail to perform the object process such that an object is created and/or generated). As another example, an object process state may be a data object that indicates that an object process is at an increased risk of suffering an anomaly (e.g., an object process may suffer from an anomaly if a correction is not made to the object process).

Additionally, or alternatively, an object process state is a data object that indicates a state associated with a subsidiary object process. For example, an object process state may be a data object that indicates that a subsidiary object process has not started. As another example, an object process state may be a data object that indicates that a subsidiary object process is in progress. As another example, an object process state may be a data object that indicates that a subsidiary object process is partially completed (e.g., a percent completed). As another example, an object process state may be a data object that indicates that a subsidiary object process is completed. As another example, an object process state may be a data object that indicates that a subsidiary object process is associated with an anomaly (e.g., due to an anomaly associated with the subsidiary object process, a processing system will fail to perform the subsidiary object process such that an object is created and/or generated). As another example, an object process state may be a data object that indicates that a subsidiary object process is at an increased risk of suffering an anomaly (e.g., a subsidiary object process may suffer from an anomaly if a correction is not made to the subsidiary object process).

In some embodiments, an object process state is determined by applying the operational data to an object process state model. In some embodiments, an object process state model is a data entity that describes parameters, hyper-parameters, and/or defined operations of a rules-based and/or machine learning model (e.g., model including at least one of one or more rule-based layers, one or more layers that depend on trained parameters, coefficients, and/or the like) configured to at least in part determine an object process state by processing operational data. The object process state model may utilize one or more of any type of machine learning and/or rules-based techniques including one or more of supervised learning (e.g., using user feedback), unsupervised learning, semi-supervised learning, reinforcement learning, computer vision techniques, sequence modeling techniques, language processing techniques, and/or neural network techniques.

In this regard, for example, an object process state model may be configured to determine that an object process and/or a subsidiary object process is associated with a not started object process state when technical data indicates that a processing system does not have the necessary technical features for performing the object process and/or the subsidiary object process. As another example, an object process state model may be configured to determine that an object process and/or a subsidiary object process is associated with an in progress object process state when distribution parameters indicate that an object is ready to be distributed. As another example, an object process state model may be configured to determine that an object process and/or a subsidiary object process is associated with a partially complete object process state when testing data indicates that two out of three tests have been successfully performed. As another example, an object process state model may be configured to determine that an object process and/or a subsidiary object process is associated with a completed object process state when registration data indicates that an object is registered in all desired geographies. As another example, an object process state model may be configured to determine that an object process and/or a subsidiary object process is associated with an object process state that indicates an anomaly when testing data indicates that a test has been unsuccessful. As another example, an object process state model may be configured to determine that an object process and/or a subsidiary object process is associated with an object process state that indicates a risk of an anomaly when genealogy data indicates an input ingredient quality index below a quality threshold.

In some embodiments, the object process optimization system 110 is configured to generate an object process state representation. In some embodiments, the object process optimization system 110 is configured to generate an object process state representation in response to determining an object process state. In this regard, for example, an object process state representation may be generated while an object process is in progress and/or when an object process has been completed.

In some embodiments, an object process state representation is a data object representative and/or indicative of an object. Additionally, or alternatively, an object process state representation is a data object representative and/or indicative of an object process. Additionally, or alternatively, an object process state representation is a data object representative and/or indicative of a plurality of subsidiary object processes. Additionally, or alternatively, an object process state representation is a data object representative and/or indicative of a processing system of the plurality of processing systems 130 associated with each of a plurality of subsidiary object processes. Additionally, or alternatively, an object process state representation is a data object representative and/or indicative of an object process state.

In some embodiments, the object process optimization system 110 is configured to initiate performance of one or more preliminary object related actions. In some embodiments, one or more preliminary object related actions are referred to as one or more preliminary object based actions. In some embodiments, the preliminary object related actions are initiated based on an object process state representation template. In this regard, for example, initiating performance of one or more preliminary object related actions includes the object process optimization system 110 being configured to generate an object process state representation template interface component 402.

In some embodiments, the object process state representation template interface component 402 includes one or more interface elements. In some embodiments, the one or more interface elements include an object interface element 404. In some embodiments, an object interface element 404 is configured to display a visual representation of an object. For example, the object interface element 404 may be configured to display a visual representation of a medical device. In some embodiments, the one or more interface elements include an object process interface element 406. In some embodiments, the object process interface element 406 is configured to display a visual representation of an object process. In some embodiments, the one or more interface elements include one or more subsidiary object process interface elements 408. In some embodiments, the one or more subsidiary object process interface elements 408 are configured to display a visual representation of one or more of subsidiary object processes. In some embodiments, the one or more interface elements include one or more processing system interface elements 410. In some embodiments, the one or more processing system interface elements 410 are configured to display a visual representation of one or more of processing systems associated with one or more subsidiary object processes. In some embodiments, initiating performance of one or more preliminary object related actions includes the object process optimization system 110 being configured to cause the object process state representation template interface component 402 to be rendered to an object process interface 400. In some embodiments, the object process interface 400 may be provided by the client device 140, the object process optimization system 110, the plurality of processing systems 130 and/or the like.

In some embodiments, initiating performance of one or more preliminary object related actions includes the object process optimization system 110 being configured to cause one or more of the plurality of processing systems 130 to perform an object process. Additionally, or alternatively, initiating performance of one or more preliminary object related actions includes the object process optimization system 110 being configured to cause one or more of the plurality of processing systems 130 to perform a subsidiary object process. For example, the object process optimization system 110 may be configured to cause a first processing system of the plurality of processing systems 130 to perform a first subsidiary object process.

In some embodiments, the object process optimization system 110 is configured to initiate performance of one or more object related actions. In some embodiments, one or more object related actions are referred to as one or more object based actions. In some embodiments, the object related actions are initiated based on an object process state representation. In this regard, for example, initiating performance of one or more object related actions includes the object process optimization system 110 being configured to generate an object process state representation interface component 502.

In some embodiments, the object process state representation interface component 502 includes one or more interface elements. In some embodiments, the one or more interface elements include the object interface element 404. In some embodiments, the one or more interface elements include the object process interface element 406. In some embodiments, the one or more interface elements include one or more subsidiary object process interface elements 408. In some embodiments, the one or more subsidiary object process interface elements 408 are organized on the object process state representation interface component 502 based on an object process state. In this regard, in some embodiments, the one or more subsidiary object process interface elements 408 are organized on the object process state representation interface component 502 based on an associated object process state. For example, a subsidiary object process interface element associated with a complete object process state may be organized such that it is below a subsidiary object process interface element associated with an in progress object process state on the object process state representation interface component 502.

In some embodiments, the one or more interface elements include one or more processing system interface elements 410. In some embodiments, the one or more interface elements include one or more object process state interface elements 512. In some embodiments, the one or more object process state interface elements 512 are configured to display a visual representation of one or more of object process states associated with one or more subsidiary object processes and/or an object process. In some embodiments, initiating performance of one or more object related actions includes the object process optimization system 110 being configured to cause the object process state representation interface component 502 to be rendered to the object process interface 400. In some embodiments, the object process interface 400 may be provided by the client device 140, the object process optimization system 110, the plurality of processing systems 130 and/or the like.

In some embodiments, initiating performance of one or more object related actions includes the object process optimization system 110 being configured to cause one or more of the plurality of processing systems 130 to stop performing an object process. Additionally, or alternatively, initiating performance of one or more preliminary object related actions includes the object process optimization system 110 being configured to cause one or more of the plurality of processing systems 130 to stop performing a subsidiary object process. For example, the object process optimization system 110 may be configured to cause a first processing system of the plurality of processing systems 130 to stop perform a first subsidiary object process. In some embodiments, the object process optimization system 110 is configured to cause a processing system to stop performing an object process and/or a subsidiary object process when an object process state indicates that an object process and/or a subsidiary object process is associated with an anomaly.

In some embodiments, initiating performance of one or more object related actions includes the object process optimization system 110 being configured to cause one or more of the plurality of processing systems 130 to adjust an object process. Additionally, or alternatively, initiating performance of one or more preliminary object related actions includes the object process optimization system 110 being configured to cause one or more of the plurality of processing systems 130 to adjust a subsidiary object process. For example, the object process optimization system 110 may be configured to cause a first processing system of the plurality of processing systems 130 to adjust a first subsidiary object process. In some embodiments, the object process optimization system 110 is configured to cause a processing system to adjust an object process and/or a subsidiary object process when an object process state indicates that an object process and/or a subsidiary object process is at an increased risk of being associated with an anomaly.

In some embodiments, initiating performance of one or more object related actions includes the object process optimization system being configured to transmit an object process state alert to the client device 140. For example, the object process optimization system may be configured to transmit an object process state alert to the client device 140 when an object process state indicates that an object process and/or a subsidiary object process is associated with an anomaly. As another example, the object process optimization system may be configured to transmit an object process state alert to the client device 140 when an object process state indicates that an object process and/or a subsidiary object process is at an increased risk of being associated with an anomaly.

### Example Methods

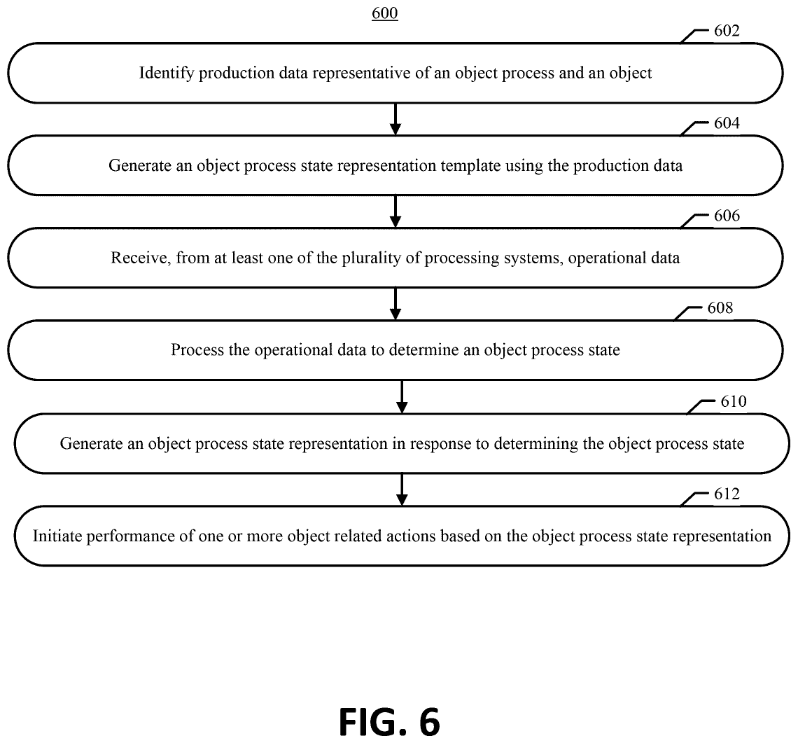

Referring now to FIG. 6, a flowchart providing an example method 600 is illustrated. In this regard, FIG. 6 illustrates operations that may be performed by the object process optimization system 110, the client device 140, and/or the plurality of processing systems. In some embodiments, the method 600 includes operations for generating an object process state representation. In some embodiments, the example method 600 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 600.

As shown in block 602, the method 600 includes identifying production data representative of an object process and an object. As described above, in some embodiments, production data includes one or more items of data representative and/or indicative of a plurality of object processes. In some embodiments, an object process is a process, routine, task, and/or the like for generating and/or creating an object that is performed by one or more of the plurality of processing systems and/or an operator associated with one or more of the plurality of processing systems. In some embodiments, an object process includes one or more subsidiary object processes. In some embodiments, a subsidiary object process is a process, routine, task, and/or the like for at least partially generating and/or creating an object that is performed by a processing system of the plurality of processing systems and/or an operator associated with a processing system of the plurality of processing systems. Said differently, for example, a subsidiary object process is associated with a portion and/or a part of an object process.

In some embodiments, production data includes one or more items of data representative and/or indicative of a plurality of objects. In some embodiments, an object is a product, item, and/or the like that is created and/or generated by an object process. For example, an object may include one or more pharmaceuticals, medical devices, biologics, manufactured devices, and/or the like. In some embodiments, production data includes one or more items of data representative and/or indicative of a plurality of resources used to generate and/or create an object and/or to perform an object process. For example, the plurality of resources may include resources used by the plurality of processing systems to generate and/or create an object and/or to perform an object process. In some embodiments, production data includes one or more items of data representative and/or indicative of equipment used to generate and/or create an object and/or to perform an object process. For example, the equipment may include equipment used by the plurality of processing systems to generate and/or create an object and/or to perform an object process (e.g., manufacturing equipment). In some embodiments, production data includes one or more items of data representative and/or indicative of material and/or input ingredients used to generate and/or create an object and/or to perform an object process. For example, the material and/or input ingredients may include material and/or input ingredients used by the plurality of processing systems to generate and/or create an object and/or to perform an object process (e.g., raw materials).

In some embodiments, identifying production data includes the object process optimization system being configured to receive production data. For example, production data may be received by the object process optimization system from one or more of the plurality of processing systems. As another example, production data may be received by the object process optimization system from one or more external systems and/or databases (e.g., the database). In some embodiments, production data may be received in a variety of standardized formats. For example, each of the plurality of processing systems may provide production data in a different format.

In some embodiments, identifying production data includes the object process optimization system being configured to generate production data. For example, production data may be generated using operational data. As another example, production data may be generated using historical production data. In some embodiments, generating production data includes the object process optimization system being configured to convert unstandardized production data received by the object process optimization system into a standard format. In this regard, for example, the object process optimization system may be configured to receive production data from the plurality of processing systems in a variety of unstandardized formats and convert the received production data into a standardized format.

As shown in block 604, the method 600 includes generating an object process state representation template using the production data. As described above, in some embodiments, an object process state representation template is a data object representative and/or indicative of an object. For example, an object process state representation template may be indicative of a first object of the plurality of objects represented by production data. Additionally, or alternatively, an object process state representation template is a data object representative and/or indicative of an object process. For example, an object process state representation template may be indicative of a first object process associated with the first object (e.g., an object process state representation template is indicative of a particular object and an object process associated with the particular object).

Additionally, or alternatively, an object process state representation template is a data object representative and/or indicative of a plurality of subsidiary object processes. For example, an object process state representation template may be indicative of a first plurality of subsidiary object processes associated with the first object process (e.g., an object process state representation template is indicative of the subsidiary object process in the first object process). Additionally, or alternatively, an object process state representation template is a data object representative and/or indicative of a processing system of the plurality of processing systems associated with each of a plurality of subsidiary object processes. For example, an object process state representation template may be indicative of a first processing system of the plurality of processing systems associated with a first subsidiary object process of the plurality of subsidiary object processes. As another example, an object process state representation template may be indicative of a second processing system of the plurality of processing systems associated with a second subsidiary object process of the plurality of subsidiary object processes. (e.g., an object process state representation template is indicative of which of the plurality of processing systems is configured to perform a particular subsidiary object process).

In some embodiments, the object process optimization system is configured to generate an object process state representation template using production data. In this regard, in some embodiments, generating an object process state representation template may include identifying and/or extracting an object from the plurality of objects represented by production data. In some embodiments, generating an object process state representation template may include identifying and/or extracting an object process associated with the identified object from the plurality of object processes represented by production data. In some embodiments, generating an object processes state representation template may include identifying and/or extracting a plurality of subsidiary object processes associated with the identified object process from the plurality of subsidiary object processes represented by the production data. In some embodiments, generating an object process state representation template may include associating and/or linking each of the plurality of subsidiary object processes with a processing system of the plurality of processing systems. For example, generating an object process state representation template may include associating and/or linking a first processing system of the plurality of processing systems with a first subsidiary object of the plurality of subsidiary processes. As another example, generating an object process state representation template may include associating and/or linking a second processing system of the plurality of processing systems with a second subsidiary object process of the plurality of subsidiary object processes. In this regard, for example, the object process optimization system is configured to determine which processing system of the plurality of processing systems should perform each subsidiary object process of the plurality of subsidiary object processes.

As shown in block 606, the method 600 includes receiving, from at least one of the plurality of processing systems, operational data. As described above, in some embodiments, operational data is received by the object process optimization system in real-time. In this regard, for example, operational data by the object process optimization system as a processing system is performing a subsidiary object process.

In some embodiments, operational data includes one or more items of data representative and/or indicative of operations of an object process and/or one or more subsidiary object processes. For example, operational data may include bioreactor parameters, temperatures, pressures, pHs, oxygen levels, dissolved oxygen levels, destructive testing parameters, reaction cycle time, and/or the like associated with an object process and/or a subsidiary object process.

In some embodiments, operational data includes testing routine data. In some embodiments, testing routine data includes one or more items of data representative and/or indicative of testing routines that are performed by one or more processing systems of the plurality of processing systems to perform an object process and/or a subsidiary object process. For example, testing routine data may include one or more items of data representative and/or indicative of one or more physical, chemical, and/or microbiological tests that are performed during an object process and/or a subsidiary object process by a processing system. In this regard, for example, testing routine data may indicate whether one or more tests performed during an object process and/or a subsidiary object process are successful or unsuccessful. In some embodiments, operational data includes production data.

In some embodiments, operational data includes genealogy data. In some embodiments, genealogy data includes one or more items of data representative and/or indicative of input ingredient quality for input ingredients that are used by one or more processing systems of the plurality of processing systems to perform an object process and/or a subsidiary object process. For example, genealogy data may include one or more items of data representative and/or indicative of an input ingredient quality index for input ingredients that are used during an object process and/or a subsidiary object process by a processing system. In this regard, for example, genealogy data may indicate whether an input ingredient quality index for input ingredients used during an object process and/or a subsidiary object process meet or do not meet a quality threshold.

In some embodiments, operational data includes labeling data. In some embodiments, labeling data includes one or more items of data representative and/or indicative of labeling associated with an object that is generated and/or created by one or more processing systems of the plurality of processing systems when performing an object process and/or a subsidiary object process. For example, labeling data may include one or more items of data representative and/or indicative of one or more labels that are fixed to an object during an object process and/or a subsidiary object process by a processing system. In this regard, for example, labeling data may indicate whether a label associated with an object meets particular regulation requirements and/or is up to date.

In some embodiments, operational data includes registration data. In some embodiments, registration data includes one or more items of data representative and/or indicative whether an object that is being generated and/or created by an object process and/or subsidiary object process has been or will be registered in one or more geographies. For example, registration data may include one or more items of data representative and/or indicative of one or more geographies in which an object needs to be registered. In some embodiments, operational data includes distribution data. In some embodiments, distribution data includes one or more items of data representative and/or indicative of distribution parameters associated with an object that is being generated and/or created by an object process and/or subsidiary object process performed by one or more processing systems of the plurality of processing systems. For example, distribution data may include one or more items of data representative and/or indicative of whether distribution parameters associated with an object indicate that an object is ready to be distributed.

In some embodiments, operational data includes technical data. In some embodiments, technical data includes one or more items of data representative and/or indicative of technical features associated with one or more processing systems of the plurality of processing systems. For example, technical data may include one or more items of data representative and/or indicative of whether a particular processing system is configured to perform a particular subsidiary object process.

As shown in block 608, the method 600 includes processing the operational data to determine an object process state. As described above, in some embodiments, an object process state is a data object that indicates a state associated with an object process. For example, an object process state may be a data object that indicates that an object process has not started. As another example, an object process state may be a data object that indicates that an object process is in progress. As another example, an object process state may be a data object that indicates that an object process is partially completed (e.g., a percent completed). As another example, an object process state may be a data object that indicates that an object process is completed. As another example, an object process state may be a data object that indicates that an object process is associated with an anomaly (e.g., due to an anomaly associated with the object process, the plurality of processing systems will fail to perform the object process such that an object is created and/or generated). As another example, an object process state may be a data object that indicates that an object process is at an increased risk of suffering an anomaly (e.g., an object process may suffer from an anomaly if a correction is not made to the object process).

Additionally, or alternatively, an object process state is a data object that indicates a state associated with a subsidiary object process. For example, an object process state may be a data object that indicates that a subsidiary object process has not started. As another example, an object process state may be a data object that indicates that a subsidiary object process is in progress. As another example, an object process state may be a data object that indicates that a subsidiary object process is partially completed (e.g., a percent completed). As another example, an object process state may be a data object that indicates that a subsidiary object process is completed. As another example, an object process state may be a data object that indicates that a subsidiary object process is associated with an anomaly (e.g., due to an anomaly associated with the subsidiary object process, a processing system will fail to perform the subsidiary object process such that an object is created and/or generated). As another example, an object process state may be a data object that indicates that a subsidiary object process is at an increased risk of suffering an anomaly (e.g., a subsidiary object process may suffer from an anomaly if a correction is not made to the subsidiary object process).

In some embodiments, an object process state is determined by applying the operational data to an object process state model. In some embodiments, an object process state model is a data entity that describes parameters, hyper-parameters, and/or defined operations of a rules-based and/or machine learning model (e.g., model including at least one of one or more rule-based layers, one or more layers that depend on trained parameters, coefficients, and/or the like) configured to at least in part determine an object process state by processing operational data. The object process state model may utilize one or more of any type of machine learning and/or rules-based techniques including one or more of supervised learning (e.g., using user feedback), unsupervised learning, semi-supervised learning, reinforcement learning, computer vision techniques, sequence modeling techniques, language processing techniques, and/or neural network techniques.

In this regard, for example, an object process state model may be configured to determine that an object process and/or a subsidiary object process is associated with a not started object process state when technical data indicates that a processing system does not have the necessary technical features for performing the object process and/or the subsidiary object process. As another example, an object process state model may be configured to determine that an object process and/or a subsidiary object process is associated with an in progress object process state when distribution parameters indicate that an object is ready to be distributed. As another example, an object process state model may be configured to determine that an object process and/or a subsidiary object process is associated with a partially complete object process state when testing data indicates that two out of three tests have been successfully performed. As another example, an object process state model may be configured to determine that an object process and/or a subsidiary object process is associated with a completed object process state when registration data indicates that an object is registered in all desired geographies. As another example, an object process state model may be configured to determine that an object process and/or a subsidiary object process is associated with an object process state that indicates an anomaly when testing data indicates that a test has been unsuccessful. As another example, an object process state model may be configured to determine that an object process and/or a subsidiary object process is associated with an object process state that indicates a risk of an anomaly when genealogy data indicates an input ingredient quality index below a quality threshold.

As shown in block 610, the method 600 includes generating an object process state representation in response to determining the object process state. As described above, in some embodiments, the object process optimization system is configured to generate an object process state representation in response to determining an object process state. In this regard, for example, an object process state representation may be generated while an object process is in progress and/or when an object process has been completed.

In some embodiments, an object process state representation is a data object representative and/or indicative of an object. Additionally, or alternatively, an object process state representation is a data object representative and/or indicative of an object process. Additionally, or alternatively, an object process state representation is a data object representative and/or indicative of a plurality of subsidiary object processes. Additionally, or alternatively, an object process state representation is a data object representative and/or indicative of a processing system of the plurality of processing systems associated with each of a plurality of subsidiary object processes. Additionally, or alternatively, an object process state representation is a data object representative and/or indicative of an object process state.

As shown in block 612, the method 600 includes initiating performance of one or more object related actions based on the object process state representation. For example, one or more object related actions may be initiated in response to generation of the object process state representation.

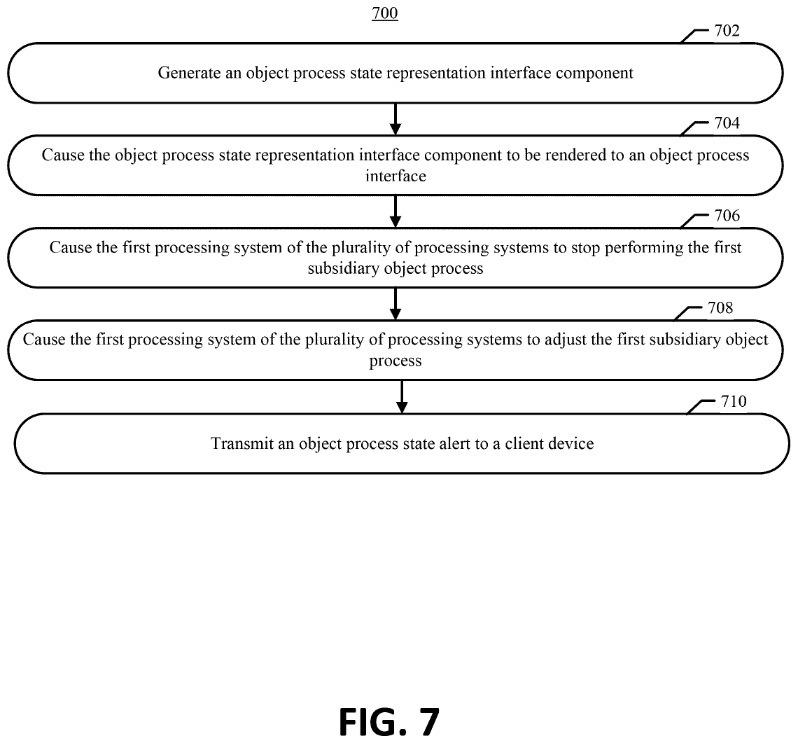

Referring now to FIG. 7, a flowchart providing an example method 700 is illustrated. In this regard, FIG. 7 illustrates operations that may be performed by the object process optimization system 110, the client device 140, and/or the plurality of processing systems. In some embodiments, the method 700 includes operations for initiating performance of one or more object related actions based on an object process state representation. In some embodiments, the example method 700 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 700.

As shown in block 702, the method 700 includes generating an object process state representation interface component. As described above, in some embodiments, the object process state representation interface component includes one or more interface elements. In some embodiments, the one or more interface elements include the object interface element. In some embodiments, the one or more interface elements include the object process interface element. In some embodiments, the one or more interface elements include one or more subsidiary object process interface elements. In some embodiments, the one or more subsidiary object process interface elements are organized on the object process state representation interface component based on an object process state. In this regard, in some embodiments, the one or more subsidiary object process interface elements are organized on the object process state representation interface component based on an associated object process state. For example, a subsidiary object process interface element associated with a complete object process state may be organized such that it is below a subsidiary object process interface element associated with an in progress object process state on the object process state representation interface component.

In some embodiments, the one or more interface elements include one or more processing system interface elements. In some embodiments, the one or more interface elements include one or more object process state interface elements. In some embodiments, the one or more object process state interface elements are configured to display a visual representation of one or more of object process states associated with one or more subsidiary object processes and/or an object process.

As shown in block 704, the method 700 includes causing the object process state representation interface component to be rendered to an object process interface. As described above, in some embodiments, initiating performance of one or more object related actions includes the object process optimization system being configured to cause the object process state representation interface component to be rendered to the object process interface. In some embodiments, the object process interface may be provided by the client device, the object process optimization system, the plurality of processing systems and/or the like.

As shown in block 706, the method 700 includes causing the first processing system of the plurality of processing systems to stop performing the first subsidiary object process. As described above, in some embodiments, the object process optimization system is configured to cause a processing system to stop performing an object process and/or a subsidiary object process when an object process state indicates that an object process and/or a subsidiary object process is associated with an anomaly.

As shown in block 708, the method 700 includes causing the first processing system of the plurality of processing systems to adjust the first subsidiary object process. As described above, in some embodiments, the object process optimization system is configured to cause a processing system to adjust an object process and/or a subsidiary object process when an object process state indicates that an object process and/or a subsidiary object process is at an increased risk of being associated with an anomaly.

As shown in block 710, the method 700 includes transmitting an object process state alert to a client device. As described above, in some embodiments, the object process optimization system may be configured to transmit an object process state alert to the client device when an object process state indicates that an object process and/or a subsidiary object process is associated with an anomaly. As another example, the object process optimization system may be configured to transmit an object process state alert to the client device when an object process state indicates that an object process and/or a subsidiary object process is at an increased risk of being associated with an anomaly.

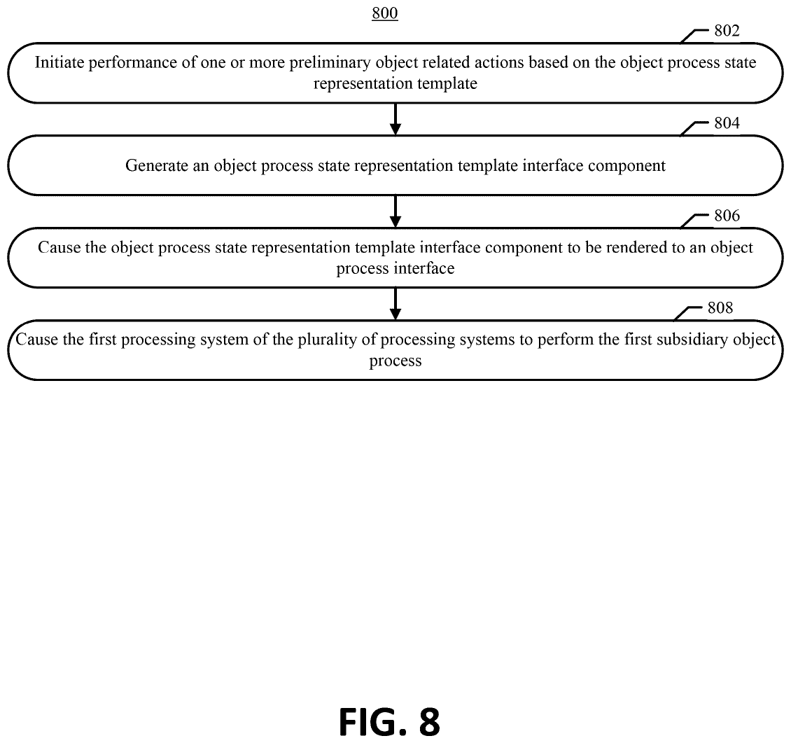

Referring now to FIG. 8, a flowchart providing an example method 800 is illustrated. In this regard, FIG. 8 illustrates operations that may be performed by the object process optimization system 110, the client device 140, and/or the plurality of processing systems. In some embodiments, the method 800 includes operations for initiating performance of one or more preliminary object related actions based on an object process state representation template. In some embodiments, the example method 800 defines a computer-implemented process, which may be executable by any of the device(s) and/or system(s) embodied in hardware, software, firmware, and/or a combination thereof, as described herein. In some embodiments, computer program code including one or more computer-coded instructions are stored to at least one non-transitory computer-readable storage medium, such that execution of the computer program code initiates performance of the method 800.

As shown in block 802, the method 800 includes initiating performance of one or more preliminary object related actions based on the object process state representation template. As described above, in some embodiments, one or more preliminary object related actions may be initiated based on a generated object process state representation template.

As shown in block 804, the method 800 includes generating an object process state representation template interface component. As described above, in some embodiments, the one or more interface elements include an object interface element. In some embodiments, an object interface element is configured to display a visual representation of an object. For example, the object interface element may be configured to display a visual representation of a medical device. In some embodiments, the one or more interface elements include an object process interface element. In some embodiments, the object process interface element is configured to display a visual representation of an object process. In some embodiments, the one or more interface elements include one or more subsidiary object process interface elements. In some embodiments, the one or more subsidiary object process interface elements are configured to display a visual representation of one or more of subsidiary object processes. In some embodiments, the one or more interface elements include one or more processing system interface elements. In some embodiments, the one or more processing system interface elements are configured to display a visual representation of one or more of processing systems associated with one or more subsidiary object processes.

As shown in block 806, the method 800 includes causing the object process state representation template interface component to be rendered to an object process interface. As described above, in some embodiments, the object process interface may be provided by the client device, the object process optimization system, the plurality of processing systems and/or the like.

As shown in block 808, the method 800 includes causing the first processing system of the plurality of processing systems to perform the first subsidiary object process. As described above, in some embodiments, initiating performance of one or more preliminary object related actions includes the object process optimization system being configured to cause one or more of the plurality of processing systems to perform an object process. Additionally, or alternatively, initiating performance of one or more preliminary object related actions includes the object process optimization system being configured to cause one or more of the plurality of processing systems to perform a subsidiary object process. For example, the object process optimization system may be configured to cause a first processing system of the plurality of processing systems to perform a first subsidiary object process.

### CONCLUSION

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method comprising:
identifying production data representative of an object process and an object, wherein the object process comprises a plurality of subsidiary object processes;
generating an object process state representation template using the production data, wherein generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes;
receiving, from at least one of the plurality of processing systems, operational data;
processing the operational data to determine an object process state, wherein processing the operational data comprises applying the operational data to an object process state model;
generating an object process state representation in response to determining the object process state; and
initiating performance of one or more object related actions based on the object process state representation.

2. The method of claim 1, wherein initiating performance of the one or more object related actions based on the object process state representation comprises:
generating an object process state representation interface component, wherein the object process state representation interface component comprises one or more interface elements; and
causing the object process state representation interface component to be rendered to an object process interface.

3. The method of claim 2, wherein the one or more interface elements comprises one or more subsidiary object process interface elements.

4. The method of claim 3, wherein the one or more subsidiary object process interface elements are organized on the object process state representation interface component based on the object process state.

5. The method of claim 1, wherein initiating performance of the one or more object related actions based on the object process state representation comprises:
causing the first processing system of the plurality of processing systems to stop performing the first subsidiary object process.

6. The method of claim 1, wherein initiating performance of the one or more object related actions based on the object process state representation comprises:
causing the first processing system of the plurality of processing systems to adjust the first subsidiary object process.

7. The method of claim 1, wherein initiating performance of the one or more object related actions based on the object process state representation comprises:
transmitting an object process state alert to a client device.

8. The method of claim 1, further comprising:
initiating performance of one or more preliminary object related actions based on the object process state representation template.

9. The method of claim 8, wherein initiating performance of the one or more preliminary object related actions based on the object process state representation template comprises:
generating an object process state representation template interface component, wherein the object process state representation template interface component comprises one or more interface elements; and
causing the object process state representation template interface component to be rendered to an object process interface.

10. The method of claim 8, wherein initiating performance of the one or more preliminary object related actions based on the object process state representation comprises:
causing the first processing system of the plurality of processing systems to perform the first subsidiary object process.

11. The method of claim 1, wherein the object process state indicates that the object process is associated with an anomaly.

12. The method of claim 1, wherein the object process state indicates that the object process is at an increased risk of suffering an anomaly.

13. An apparatus comprising memory and one or more processors communicatively coupled to the memory, the one or more processors configured to:
identify production data representative of an object process and an object, wherein the object process comprises a plurality of subsidiary object processes;
generate an object process state representation template using the production data, wherein generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes;
receive, from at least one of the plurality of processing systems, operational data;
process the operational data to determine an object process state, wherein processing the operational data comprises applying the operational data to an object process state model;
generate an object process state representation in response to determining the object process state; and
initiate performance of one or more object related actions based on the object process state representation.

14. The apparatus of claim 13, wherein to initiate performance of the one or more object related actions based on the object process state representation comprises the one or more processors being further configured to:
generate an object process state representation interface component, wherein the object process state representation interface component comprises one or more interface elements; and
cause the object process state representation interface component to be rendered to an object process interface.

15. The apparatus of claim 14, wherein the one or more interface elements comprises one or more subsidiary object process interface elements.

16. The apparatus of claim 15, wherein the one or more subsidiary object process interface elements are organized on the object process state representation interface component based on the object process state.

17. The apparatus of claim 13, wherein to initiate performance of the one or more object related actions based on the object process state representation comprises the one or more processors being further configured to:
cause the first processing system of the plurality of processing systems to stop performing the first subsidiary object process.

18. The apparatus of claim 13, wherein to initiate performance of the one or more object related actions based on the object process state representation comprises the one or more processors being further configured to:
cause the first processing system of the plurality of processing systems to adjust the first subsidiary object process.

19. The apparatus of claim 13, wherein the one or more processors are further configured to:
initiate performance of one or more preliminary object related actions based on the object process state representation template.

20. A computer program product comprising at least one non-transitory computer-readable storage medium having computer program code stored thereon that, in execution with at least one processor, configures the computer program product for:
identifying production data representative of an object process and an object, wherein the object process comprises a plurality of subsidiary object processes;
generating an object process state representation template using the production data, wherein generating the object process state representation template comprises associating a first processing system of a plurality of processing systems with a first subsidiary object process of the plurality of subsidiary object processes and a second processing system of the plurality of processing systems with a second subsidiary object process of the plurality of subsidiary object processes;
receiving, from at least one of the plurality of processing systems, operational data;
processing the operational data to determine an object process state, wherein processing the operational data comprises applying the operational data to an object process state model;
generating an object process state representation in response to determining the object process state; and
initiating performance of one or more object related actions based on the object process state representation.
